(19) United States
(12) Patent Application Publication
(10) Pub. No.: US 2006/0159046 A1
(43) Pub. Date: Jul. 20, 2006

(54) Method and apparatus for sharing spectrum for voice over Internet protocol application

(76) Inventor: Barry Boes, Austin, TX (US)

Correspondence Address: HAMILTON & TERRILE, LLP, P.O. BOX 203518, AUSTIN, TX, 78720, US

(21) Appl. No.: 11/037,315

(22) Filed: Jan. 18, 2005

(51) Int. Cl. H04Q 7/00

(52) U.S. Cl. 370/331

(57) ABSTRACT

The present invention provides for simultaneous transmission, without interference, for a plurality of wireless devices operating in the same frequency spectrum. In particular, the present invention provides for simultaneous operation of devices using 802.11 communication protocols and devices using Bluetooth communication protocols within the same frequency spectrum. A first information handling system is enabled for wireless communication using a first communication protocol, a second information handling system is enabled for wireless communication using the first protocol and is further enabled for wireless communication using a second communication protocol. A wirelessly enabled device is operable to communicate with the second information handling system using the second communication protocol. The communication of data using the first and second communication protocols is restricted to a predetermined frequency spectrum wherein communication of data using the first and second communication protocols is restricted to first and second sets of predetermined channels within the predetermined frequency spectrum.

### BACKGROUND OF THE INVENTION

1. Field of the Invention

The present invention relates in general to the field of information handling systems and, more specifically, to management of wireless communications between information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

An increasingly mobile lifestyle is creating the need for Wireless Personal Area Networks (WPANs) consisting of ad-hoc communications between portable computing devices such as laptops, PDAs, pagers and cellular telephones. What is emerging today are wireless technologies, including 802.11 and Bluetooth, that promise to outfit portable and embedded devices with high bandwidth, and localized wireless communication capabilities that can also reach the globally wired Internet.

Many current Personal Data Assistants (PDAs) are equipped with 802.11b/g WiFi capabilities as standard equipment. Concurrently, Voice-over-Internet Protocol (VoIP) as a means of voice communication transport is gaining market acceptance. A growing percentage of today's PDAs are dual-purposed as mobile phones, so combined with the PDA's inherent WiFi capabilities, VoIP is becoming an attractive and complementary mechanism. Many of these same PDAs use Bluetooth for close proximity wireless attachment to any number of peripherals, most notably headsets. Bluetooth-enabled headsets, combined with WiFi for data exchange and VoIP for voice communication, enable applications requiring concurrent voice/data interaction (e.g., field service maintenance).

Bluetooth, WiFi, and by extension VoIP, all use the 2.4 GHz ISM (Industrial, Scientific and Medical) band. Sharing this spectrum can cause interference problems due to time sensitive data packets being transmitted simultaneously by both Bluetooth and WiFi. Today, when Bluetooth and WiFi are used simultaneously (e.g., WiFi-enabled PDA and a Bluetooth headset), and in close proximity to each other (less than one meter), the Bluetooth voice traffic, which is connection-oriented, suffers from drop-out (gaps in the conversation, e.g., lost syllables). In addition, WiFi data traffic, which uses packet collision detection, experiences reduced throughput due to packet retransmission. Market deployment of VoIP will acerbate this problem for dual-purposed PDAs that use VoIP for voice communications.

A method for simultaneous transmission, without interference, does not exist today in either hardware designs or software algorithms.

### SUMMARY OF THE INVENTION

The method and apparatus of the present invention overcomes the shortcomings of the prior art by providing for simultaneous transmission, without interference, for a plurality of wireless devices operating in the same frequency spectrum. In particular, the method and apparatus of the present invention provides for simultaneous operation of devices using 802.11 communication protocols and devices using Bluetooth communication protocols within the same frequency spectrum. In one embodiment of the invention, a first information handling system is enabled for wireless communication using a first communication protocol, a second information handling system is enabled for wireless communication using said first protocol and is further enabled for wireless communication using a second communication protocol. A wirelessly enabled device is operable to communicate with said second information handling system using said second communication protocol. The communication of data using the first and second communication protocols is restricted to a predetermined frequency spectrum wherein communication of data using the first and second communication protocols is restricted to first and second sets of predetermined channels within the predetermined frequency spectrum. In one embodiment of the invention, the wirelessly enabled device communicating with the second information handling system comprises a human interface device (HID) communicating in accordance with the Bluetooth communication protocol. In one embodiment of the invention, the first communication protocol is compliant with an 802.11 protocol standard and can be used for voice-over-Internet (VoIP). Using the method and apparatus of the present invention, transmitter and receiver frequency conflicts are resolved to minimize interference between the devices using the first and second communication protocols.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is an illustration of a plurality of information handling systems enabled for wireless communication in accordance with the present invention.

FIG. 2 is a block diagram of an information handling system in accordance with the present invention.

FIGS. 3a-c are illustrations of frequency spectra allocations for first and second communication protocols within a single frequency spectrum.

FIG. 4 is a flowchart illustration of a processing sequence in accordance with the present invention.

### DETAILED DESCRIPTION

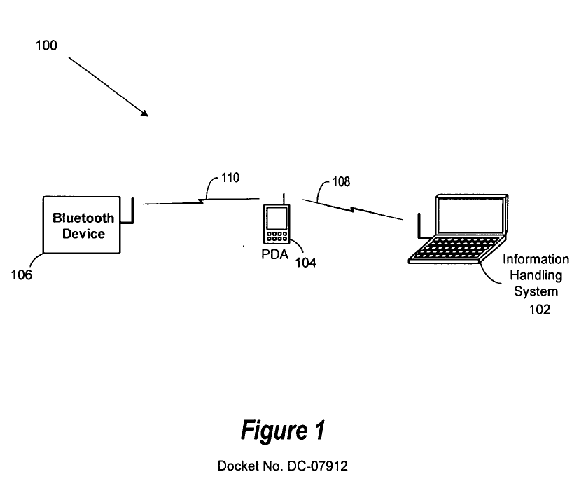

FIG. 1 is an illustration of a system for wireless communication between a plurality of information handling systems and wirelessly enabled devices 106. In the system illustrated in FIG. 1, an information handling system 102 is enabled for wireless communication with a personal digital assistant (PDA) 104. The PDA 104 is further enabled for wireless communication with a wirelessly enabled device such as a human interface device operating in accordance with the Bluetooth standard. In one embodiment of the invention, the information handling system 102, PDA 104, and HID device 106 communicate using first and second communication protocols. For example, communications between the information handling system 102 and the PDA 104 can be implemented using a communication channel 108 in accordance with the IEEE 802.11 communication protocol as discussed in greater detail hereinbelow. Furthermore, the communications between the PDA 104 and the HID device 106 can be enabled using a communication channel 110 established in accordance with the Bluetooth standard as discussed in greater detail hereinbelow. As will be understood by those of skill in the art, each of the communication channels 108 and 110 may operate in the same frequency spectrum, in the 2.4 MHz spectrum. Furthermore, as discussed hereinabove, communications using the Bluetooth protocol requires frequency hopping which can result in interference with transmissions using the 802.11 standard for transmission channel 108. The present invention, as discussed in greater detail below, provides a method and apparatus for resolving interferences resulting from transmission over channels 108 and 110 using the 802.11 and Bluetooth protocols. The present invention makes it possible to implement voice-over-Internet protocol (VoIP), while also allowing data communication between the PDA 104 and the information handling system 102 using the 802.11 communication protocol.

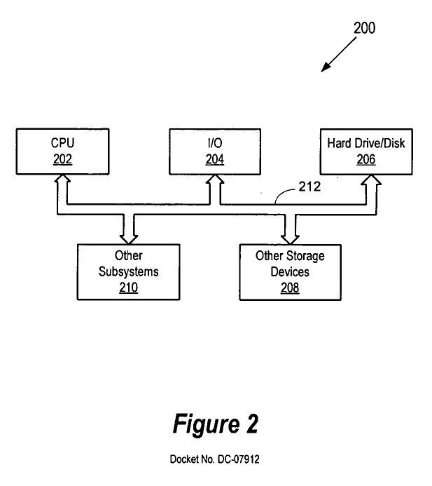

FIG. 2 is a generalized illustration of an information handling system 200. The functional components of the information handling system 200 can be implemented in the various information handling systems illustrated in FIG. 1, including the server, personal computer and handheld computer. The information handling system includes a processor 202, input/output (I/O) devices 204, such as a display, a keyboard, a mouse, and associated controllers, a memory drive 206, and other storage devices 208, that may include a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As will be understood by those of skill in the art, the Bluetooth protocol uses Frequency Hopping Spread Spectrum (FHSS), “hopping” up to seventy nine 1 Mhz channels at the end of every data packet transmission/receipt to avoid interference. However, the Bluetooth protocol only addresses direct transmitter/receiver frequency conflicts and does not resolve interference from other sources, such as adjacent channels, spurious signals, or image frequencies.

In prior systems, Bluetooth and WiFi antenna isolation between side lobes has resolved this issue in laptop implementations, but the small form factor of a PDA does not allow sufficient distance between antennas. In the method and apparatus of the present invention, a plurality of channels are defined for the Bluetooth transmissions to “hop” within, thereby reducing possible interference with WiFi data traffic, and by extension, VoIP voice communication. Specifically, the method and apparatus of the present invention addresses: a) image, spurious and adjacent channel performance; b) path loss between the inter-PDA Bluetooth and WiFi antennas; and c) radio sensitivity.

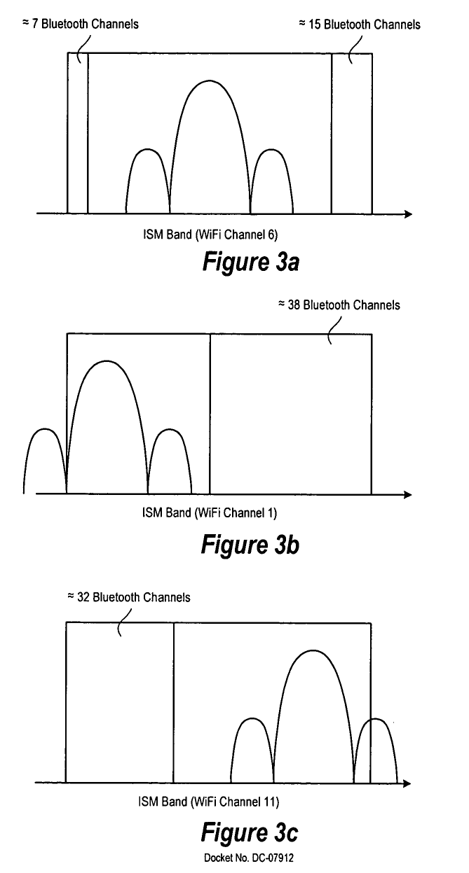

FIGS. 3a-c are illustrations of possible allocations of frequency spectra within the 2.4 GHz frequency spectra used for 802.11 and Bluetooth communication protocols. In FIG. 3a, the ISM band (WiFi) channel 6 frequency spectrum is illustrated. As can be seen in FIG. 3a, approximately seven Bluetooth channels are available to the left of the frequency spectra allocated to channel 6 and approximately fifteen Bluetooth channels are allocated to the right of the frequency spectra for channel 6. Because of the low number of possible Bluetooth channels available in the illustration shown in FIG. 3a, operation of the HID device 106 is compromised. FIGS. 3b and 3c illustrate allocations of the frequency spectra wherein alternate WiFi channels are selected and a larger number of Bluetooth channels are available for communication using the Bluetooth standard. For example, in the illustration shown in FIG. 3b, WiFi channel 1 is selected, resulting in thirty-eight Bluetooth channels for communications between the Bluetooth device 106 and the PDA 104. In the example shown in FIG. 3c, WiFi channel 11 is selected for 802.11 communications, thereby leaving thirty-two Bluetooth channels for communications between the HID device 106 and the PDA 104.

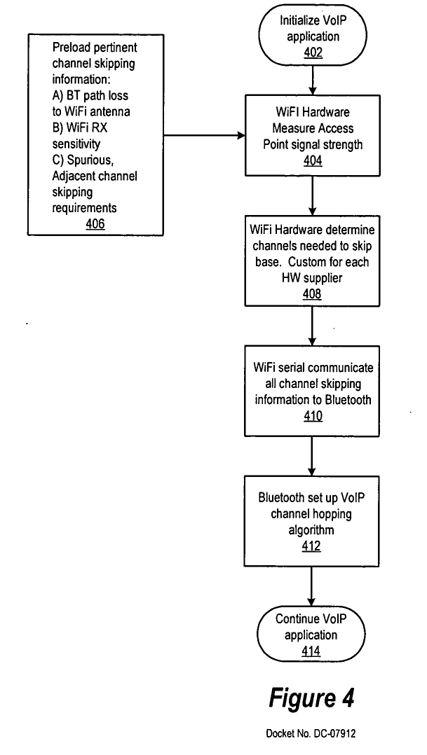

FIG. 4 is a flowchart illustration of the processing sequence for implementing the method and apparatus of the present invention. In step 402, the voice-over IP application is initialized. In step 404, the WiFi hardware measures access point signal strength, and in step 406 pertinent channel skipping information is pre-loaded. The channel skipping information loaded in step 406 includes Bluetooth path loss to the WiFi antenna; WiFi receiver sensitivity; and spurious adjacent channel skipping requirements. In step 408, the WiFi hardware determines channels needed to skip base, which is customized for each hardware supplier. In step 410, channel skipping information is provided to Bluetooth hardware in the HID device 106 and the PDA 104 to enable implementation of a channel algorithm in accordance with a Bluetooth standard in step 412. In step 414, voice-over IP communications is conducted. Those of skill in the art will appreciate that the method and apparatus of the present invention can be used to allocate frequency spectra for the information handling system 102, the PDA 104 and the HID 106.

Although the present invention has been described in detail, it should be understood that various changes, substitutions and alterations can be made hereto without departing from the spirit and scope of the invention as defined by the appended claims.

What is claimed is:

1. A system for communicating information over a wireless network, comprising:
a first information handling system, said first information system being enabled for wireless communication using a first communication protocol;
a second information handling system, said second information handling system being enabled for wireless communications with said first information handling system using said first protocol and further enabled for wireless communication using a second communication protocol; and
a wirelessly enabled device operable to communicate with said second information handling system using said second communication protocol;
wherein said communication of data using said first and second communication protocols is restricted to a predetermined frequency spectrum and wherein communication of data using said first and second communication protocols is restricted to first and second sets of predetermined channels, respectively, within said predetermined spectrum.

2. The system of claim 1, wherein said first information handling system comprises a personal computer.

3. The system of claim 1, wherein said second information handling system comprises a personal digital assistant.

4. The system of claim 1, wherein said wirelessly enabled device comprises a human interface device.

5. The system of claim 1, wherein said first communication protocol comprises a protocol that is compliant with an 802.11 protocol standard.

6. The system of claim 1, wherein said second communication protocol comprises a frequency hopping sequence using said second set of predetermined channels.

7. The system of claim 6, wherein said second communication protocol is compliant with a Bluetooth protocol standard.

8. The system of claim 5, wherein communications using said first communication protocol comprise voice-over-Internet (VoIP) communications.

9. The system of claim 7, wherein communications using said second communication protocol comprise voice communications.

10. The system of claim 4, wherein said human interface device comprises a wireless headset operating in accordance with said Bluetooth communication protocol.

11. A method for communicating over a network, comprising:
transmitting data between a first information handling system and a second information handling system using a first communication protocol;
transmitting data between said second information handling system and a wirelessly enabled device using a second communication protocol;
wherein said communication of data using said first and second communication protocols is restricted to a predetermined frequency spectrum and wherein communication of data using said first and second communication protocols is restricted to first and second sets of predetermined channels, respectively, within said predetermined spectrum.

12. The method of claim 11, wherein said first information handling system comprises a personal computer.

13. The method of claim 11, wherein said second information handling system comprises a personal digital assistant.

14. The method of claim 11, wherein said wirelessly enabled device comprises a human interface device.

15. The method of claim 11, wherein said first communication protocol comprises a protocol that is compliant with an 802.11 protocol standard.

16. The method of claim 11, wherein said second communication protocol comprises a frequency hopping sequence using said second set of predetermined channels.

17. The method of claim 16, wherein said second communication protocol is compliant with a Bluetooth protocol standard.

18. The method of claim 15, wherein communications using said first communication protocol comprise voice-over-Internet (VoIP) communications.

19. The method of claim 17, wherein communications using said second communication protocol comprise voice communications.

20. The method of claim 14, wherein said human interface device comprises a wireless headset operating in accordance with said Bluetooth communication protocol.
